(19) United States
(12) Patent Application Publication
(10) Pub. No.: US 2007/0018963 A1
(43) Pub. Date: Jan. 25, 2007

(54) Tablet hot zones

(75) Inventor: Juilian A.Q. Spencer, Tustin, CA (US)

Correspondence Address: GATEWAY, INC.;ATTN: Patent Attorney, 610 GATEWAY DRIVE, MAIL DROP Y-04, N. SIOUX CITY, SD, 57049, US

(73) Assignee: Gateway Inc.

(21) Appl. No.: 11/184,684

(22) Filed: Jul. 19, 2005

(51) Int. Cl. G09G 5/00

(52) U.S. Cl. 345/173

(57) ABSTRACT

Programmable zones can be configured to allow commands, application software, macros, and/or utilities to be executed by tapping in a predetermined and programmed area on a digitizer screen. Hot spots can be used on any computer with a digitizer or touch screen.

### BACKGROUND OF THE INVENTION

1. Field of the Invention

The present invention relates to devices, systems, and processes useful with tablet-type computing devices.

2. Brief Description of the Related Art

When using a notebook or slate with a tablet-enabling operating system, e.g., Microsoft Windows XP Tablet, loaded, it is oftentimes very difficult to manipulate application programs that are running in full screen mode. One non-limiting example would be when running a full screen photo or image viewer. In order to switch to the next picture in such an application, the user needs to actuate a key, e.g., the space bar, or to go back an image, typically another key, e.g., the backspace key, must be actuated. While in full screen mode, however, the user sometimes cannot access any of these keys without bringing up the keyboard display on the tablet, which then obstructs the user's view of the image.

Programmable touch pads per se have been proposed and are currently available, but such touch pads are not incorporated into tablets. Operating systems and applications have also been proposed that permit users of general purpose computing devices, e.g., personal computers (PC), to program keys or buttons on the keyboards of such computers, but such programming is not used “on screen.” Personal Digital Assistant devices, such as those running the Palm OS operating system, allow manipulation of data on these devices, but the application programs are designed especially for this environment and not for tablet-type or other more general computing devices.

There remains a need, therefore, for systems, devices, and processes that ease the use of tablet-type computing devices, especially when displaying the graphical user interface (GUI) of an application in full-screen mode.

### SUMMARY OF THE INVENTION

According to a first aspect of the invention, a method of initiating an action comprises providing a graphical display with a digitizer input device, reserving a predefined location on said graphical display corresponding to an initiating action, receiving an input stimulus to said predefined location, and initiating an action in response to said receiving an input stimulus.

According to another aspect of the present invention, a tablet computing device includes an operating system and a memory, and the device comprises means for providing a graphical display and a digitizer input device, means for reserving a predefined location on said graphical display corresponding to an initiating action, means for receiving an input stimulus to said predefined location, and means for initiating an action in response to said receiving an input stimulus.

According to yet another aspect of the present invention, a tablet computing device includes an operating system and a memory, and the device comprises logic configured to provide a graphical display and a digitizer input device, logic configured to reserve a predefined location on said graphical display corresponding to an initiating action, logic configured to receive an input stimulus to said predefined location, and logic configured to initiate an action in response to said receiving an input stimulus.

Still other objects, features, and attendant advantages of the present invention will become apparent to those skilled in the art from a reading of the following detailed description of embodiments constructed in accordance therewith, taken in conjunction with the accompanying drawings.

### BRIEF DESCRIPTION OF THE DRAWINGS

The invention of the present application will now be described in more detail with reference to preferred embodiments of the apparatus and method, given only by way of example, and with reference to the accompanying drawings, in which:

FIG. 1 schematically illustrates a front elevational view of the display and digitizer of a tablet-type computing device, including multiple software application GUIs in non-full screen mode.

FIG. 2 schematically illustrates a front elevational view of the display and digitizer of a tablet-type computing device, including a single software application GUI in full screen mode and hot spots in accordance with the present invention.

FIG. 3 illustrates an exemplary lookup table in accordance with the present invention.

### DETAILED DESCRIPTION OF THE PREFERRED EMBODIMENTS

Referring to the drawing figures, like reference numerals designate identical or corresponding elements throughout the several figures.

In general terms, an aspect of the present invention permits a user of a tablet-type computing device to control application software running on the tablet with the stylus, instead of by pressing exterior buttons. Another aspect includes logic configured to permit a user to program zones or hot spots on the tablet so that one or more programs can be manipulated the way the user wants, and these program(s) not merely being application software written specifically for touch screen devices.

Another aspect of the present invention includes programmable zones that can be configured to allow commands, application software, and/or utilities to be executed by tapping in a predetermined and programmed area on the digitizer screen. Yet another aspect includes that hot spots of the present invention can be used on any computer type device that has a digitizer or touch screen. The hot spots can be made programmable such that they can be used with any program (not just with programs written specifically for touch screen or tablet type devices).

Another aspect of the present invention includes logic, e.g., a set of computer-executable instructions contained on, or in communication with, the tablet computing device, that allows a user to set up programmable zones that can be assigned a key stroke or shortcut that is activated by tapping the screen in that zone or area of the touch screen. These zones can be not displayed on the screen according to one embodiment of the present invention, e.g., is or are transparent to the user, so as not to obstruct the view of whatever was being displayed on the screen. According to another embodiment of the present invention, the logic can be configured to permit the user the option of having the areas or zones displayed in some manner, e.g., in the form of a button, icon, semi-transparent area.

Another aspect of the present invention includes a method of configuring programmable zones on a tablet PC so as to allow one or more commands, programs, and/or utilities to be executed by tapping in a predetermined area on the digitizer screen.

Yet another aspect of the present invention includes that there could be as few as one hot spot area covering a predetermined amount of the screen, yet the present invention extends to and includes that the logic is configured to permit a plurality of such hot spots. In addition, it is yet another aspect of the present invention that one hidden hot spot can serve as a directory of other hot spots such that the “directory” hot spot lights up a plurality of indicia or semi-transparent hot spots for the user to see.

At least one of the many benefits of the present invention includes that the user can more easily manipulate software applications that are presented in full screen mode on a tablet-type computing device.

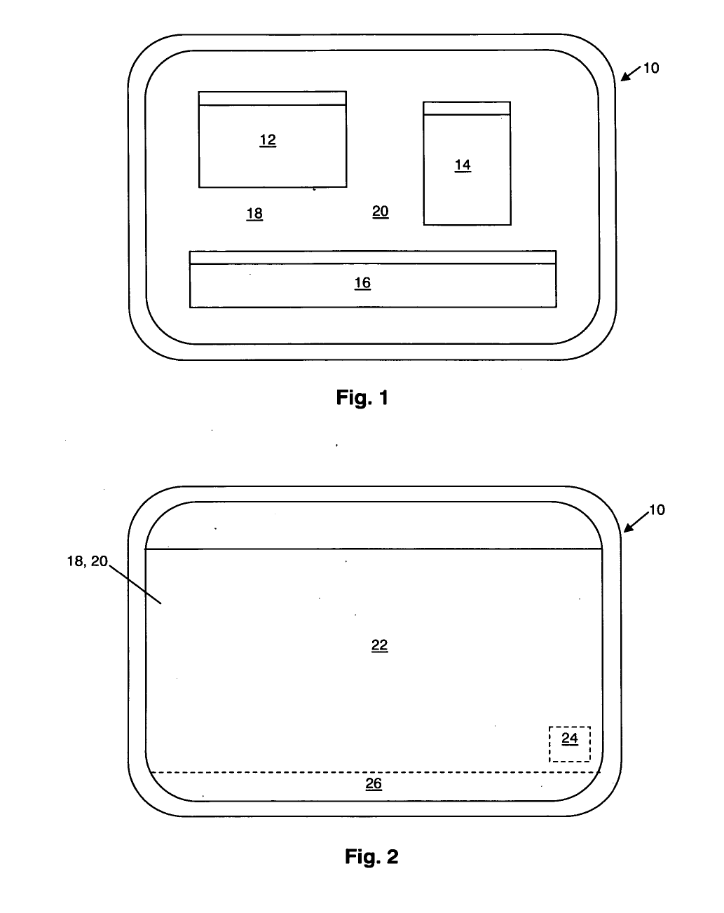

Turning now to the drawing figures, FIG. 1 schematically illustrates a front elevational view of the display (e.g., LCD display) 18 and digitizer 20 of a tablet-type computing device 10, including multiple software application GUIs 12, 14, 16 in non-full screen mode. As described herein, when such application software GUIs are displayed in a non-full screen mode, the user has access to other portions of the digitizer 20, and can therefore more easily manipulate the applications by tapping (e.g., with a stylus or finger) the touch screen in a manner that is recognized by the logic of the tablet computing device's operating system or other software logic.

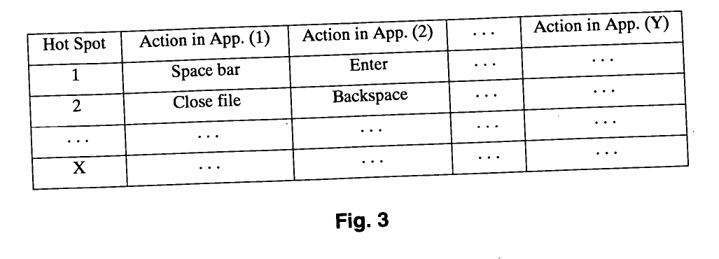

When the device 10 displays the GUI of a software application 22 in full screen mode, as schematically illustrated in FIG. 2, the user does not have physical access to a portion or portions of the touch screen not associated with the one application 22. According to an exemplary embodiment of the present invention, the tablet computing device 10 includes (that is, is stored in memory that is part of the device 10 or is in communication with the device 10) a set of computer-executable logical instructions that are configured to permit a user of the device 10 to define one or more hot spots, zone, or areas 24, 26. Each hot spot 1, 2, . . . , X is defined by a set or range of coordinates on the digitizer 20. By way of non-limiting examples, a rectangle or square 24, or a particular portion of the outside margin 26 of the digitizer (e.g., the lower ½ inch) can be assigned to a particular action in one or more software applications. As suggested in the exemplary table presented in FIG. 3, the logic of the present invention can be configured to associate hot spot 1 with the action of “space bar” in software application (1), and to associate hot spot 2 with the action of “close file” in the same software application.

Another optional aspect of the present invention includes, as also suggested in FIG. 3, that the logic of the present invention is configured so that tapping on the same hot spots are interpreted differently for different software applications, including the operating system of the device 10. More particularly, tapping on hot spot 1 while software application (2) is the active application is interpreted by the logic of an embodiment of the present invention to mean “enter”, while tapping on hot spot 2 while software application (2) is the active application is interpreted by the logic of an embodiment of the present invention to mean “backspace”. Preferably, the logic is configured to permit any number X of hot spot definitions, and to permit correlation of the execution of commands, keystrokes, macros, other software applications, and/or utilities, with those X hot spots for Y software applications. As readily appreciated by those of ordinary skill in the art, X and Y can be any positive integers. By way of non-limiting example, the logic can be configured to bring to the front the keyboard emulation software application of the device 10 when one of the hotspots is tapped, in one or more of the applications 1, 2, . . . Y.

Yet another aspect of the present invention is how the hot spots 24, 26 are displayed by the display 18 of the device 10. Preferably, the logic is configured so that the user can select how the hot spots will be displayed, from among a plurality of options. Such options can include, but are not limited to: transparent hot spots (i.e., the hot spots are not displayed); active hot spots (i.e., are displayed only when the digitizer 20 detects that the hot spot has been tapped); translucent hot spots (i.e., the image that would be displayed on the display 18, were the hot spot not present, is modified, colored differently, faded, or similarly changed); and a button(s) or icon(s) that completely obscures the image that would appear behind the hot spot.

While the invention has been described in detail with reference to preferred embodiments thereof, it will be apparent to one skilled in the art that various changes can be made, and equivalents employed, without departing from the scope of the invention.

What is claimed is:

1. A method of initiating an action comprising:
providing a graphical display with a digitizer input device;
reserving a predefined location on said graphical display corresponding to an initiating action;
receiving an input stimulus to said predefined location; and
initiating an action in response to said receiving an input stimulus.

2. A method of initiating an action according to claim 1, wherein said graphical display is an LCD display and said digitizer input device is a touch screen.

3. A method of initiating an action according to claim 1, wherein said receiving an input stimulus comprises tapping on said graphical display at said predefined location.

4. A method of initiating an action according to claim 1, wherein said receiving an input stimulus comprises tapping on said graphical display at said predefined location with a stylus.

5. A method of initiating an action according to claim 1, wherein said receiving an input stimulus comprises tapping on said graphical display at said predefined location with a finger.

6. A method of initiating an action according to claim 1, wherein said initiating an action comprises initiating a software application.

7. A method of initiating an action according to claim 1, wherein said predefined location is indicated by indicia selected from the group consisting of an icon, a button, a transparent area, and a non-visible area.

8. A tablet computing device including an operating system and a memory, the device comprising:
means for providing a graphical display and a digitizer input device;
means for reserving a predefined location on said graphical display corresponding to an initiating action;
means for receiving an input stimulus to said predefined location; and
means for initiating an action in response to said receiving an input stimulus.

9. A tablet computing device according to claim 8, wherein said graphical display comprises an LCD display and said digitizer input device comprises a touch screen.

10. A tablet computing device according to claim 8, wherein said means for receiving comprises means for interpreting tapping on said graphical display at said predefined location.

11. A tablet computing device according to claim 8, wherein said means for receiving comprises means for interpreting tapping on said graphical display at said predefined location with a stylus.

12. A tablet computing device according to claim 8, wherein said means for receiving comprises means for interpreting tapping on said graphical display at said predefined location with a finger.

13. A tablet computing device according to claim 8, wherein said means for initiating comprises means for initiating a software application.

14. A tablet computing device according to claim 8, wherein said predefined location is indicated by indicia selected from the group consisting of an icon, a button, a transparent area, and a non-visible area.

15. A tablet computing device including an operating system and a memory, the device comprising:
logic configured to provide a graphical display and a digitizer input device;
logic configured to reserve a predefined location on said graphical display corresponding to an initiating action;
logic configured to receive an input stimulus to said predefined location; and
logic configured to initiate an action in response to said receiving an input stimulus.

16. A tablet computing device according to claim 15, wherein said graphical display comprises an LCD display and said digitizer input device comprises a touch screen.

17. A tablet computing device according to claim 15, wherein said logic configured to receive comprises logic configured to interpret tapping on said graphical display at said predefined location.

18. A tablet computing device according to claim 15, wherein said logic configured to receive comprises logic configured to interpret tapping on said graphical display at said predefined location with a stylus.

19. A tablet computing device according to claim 15, wherein said logic configured to receive comprises logic configured to interpret tapping on said graphical display at said predefined location with a finger.

20. A tablet computing device according to claim 15, wherein said logic configured to initiate comprises logic configured to initiate a software application.

21. A table computing device according to claim 15, wherein said predefined location is indicated by indicia selected from the group consisting of an icon, a button, a transparent area, and a non-visible area.
